(19) United States
(12) Patent Application Publication
(10) Pub. No.: US 2004/0234358 A1
(43) Pub. Date: Nov. 25, 2004

(54) Fastener assembly and method employing a flanged metal nut with a metal cup washer rotatably mounted thereon

(75) Inventor: Raymond Genick, Waterford, MI (US)

Correspondence Address: MILES & STOCKBRIDGE PC, 1751 PINNACLE DRIVE, SUITE 500, MCLEAN, VA, 22102-3833, US

(73) Assignee: Newfrey LLC

(21) Appl. No.: 10/442,167

(22) Filed: May 21, 2003

(51) Int. Cl. F16B 43/00

(52) U.S. Cl. 411/533

(57) ABSTRACT

A fastener assembly comprises a metal nut having an integral flange and a metal cup washer rotatably mounted on the flange, with an outer disc surface of the flange adjacent to an inner disc surface of the washer, and with portions of a sidewall of the washer overlying the flange to hold the washer captive on the flange. An outer disc surface of the washer, which engages a surface of a workpiece, has a plurality of grooves extending transversely to the circumference of the outer disc surface. The entire fastener assembly is coated, as a unit, with an anti-corrosive lubricant. The grooves provide a frictional force between the washer and the workpiece that exceeds the frictional force between the nut and the washer, but do not mar the workpiece surface.

### BACKGROUND OF THE INVENTION

This invention is concerned with an improved fastener assembly comprising a flanged metal nut with a metal cup washer rotatably mounted thereon, and is also concerned with an improved method of providing such a fastener assembly.

Fastener assemblies of the foregoing type are well known. See, e.g., U.S. Pat. No. 4,986,712 granted Jan. 22, 1991 to Fultz.

As stated in the Fultz patent, it is highly desirable to be able to obtain a uniform predictable tension by tightening a nut to a predetermined torque in a variety of applications. As further stated in the Fultz patent, to facilitate relative rotation between the flanged nut and the cup washer, the cup washer is covered with plain zinc and the flanged nut has a cadmium base coating with a top wax coating, so that the coefficient of friction between the work surface and the cup washer will be higher than the coefficient of friction between the washer and the nut. The Fultz patent also mentions that the desired friction coefficient relationship can be achieved by variation in sizes of the bearing areas and configuration of bearing areas at washer to work surface interface, e.g., serrations or non-circular washer geometries, so that the nut will rotate relative to the stationary washer during final tightening.

### BRIEF DESCRIPTION OF THE INVENTION

An object of the present invention is to provide an improved fastener assembly comprising a flanged metal nut with a metal cup washer rotatably mounted thereon.

A more specific object of the present invention is to provide an improved fastener assembly of the foregoing type in which the desired relationship between the frictional force at the nut-washer interface and the frictional force at the washer-workpiece interface is achieved without requiring separate coating of the nut and the washer and without requiring variation in sizes of bearing areas and configuration of bearing areas at washer to work surface interface or using serrations or non-circular washer geometries.

Yet another object of the invention is to provide an improved fastener assembly of the foregoing type which avoids marring of a workpiece/washer interface, as can occur with knurling, ribbing, or otherwise roughening a surface of the washer that engages the workpiece.

A further object of the invention is to provide an improved method of manufacturing a fastener assembly of the foregoing type.

In accordance with one aspect of the invention, a fastener assembly comprises a metal nut having an integral flange at one end, a metal cup washer rotatably mounted on the flange of the nut, with an outer disc surface of the flange adjacent to an inner disc surface of the washer, and with at least portions of a sidewall of the washer overlying the flange of the nut, wherein an outer disc surface of the washer, for engagement with a surface of a workpiece, has a plurality of grooves extending transversely to the circumference of the outer disc surface of the washer. In an embodiment of the invention, the grooves are disposed radially on a smooth, flat outer disc surface of the washer and have a substantially U-shaped cross-sectional configuration.

According to another aspect of the invention, the entire fastener assembly is coated, as a unit, with an anti-corrosive lubricant. To facilitate such coating, the mounting of the washer on the flange of the nut is sufficiently loose as to provide substantial amounts of axial, lateral, and tilting movement of the flanged nut relative to the cup washer, so that a substantial space is provided between an outer disc surface of the flange and an inner disc surface of the cup washer for entry of the lubricant in a liquid bath.

### BRIEF DESCRIPTION OF THE DRAWINGS

The invention will be further described in conjunction with the accompanying drawings, which illustrate preferred (best mode) embodiments of the invention, and wherein:

FIG. 1 is a top plan view of a fastener assembly according to the invention;

FIG. 2 is a sectional view taken along line 2-2 in FIG. 1;

FIG. 3 is a bottom plan view of a fastener assembly according to the invention;

FIG. 4 is a sectional view taken along line 4-4 in FIG. 3;

FIG. 5 is a somewhat diagrammatic view showing a fastener assembly coating process in accordance with the invention;

FIG. 5A is a view similar to FIG. 5 showing axial movement of the flanged nut relative to the cup washer; and

FIG. 5B is a view similar to FIG. 5 showing tilting movement of the flanged nut relative to the cup washer.

### DETAILED DESCRIPTION OF THE INVENTION

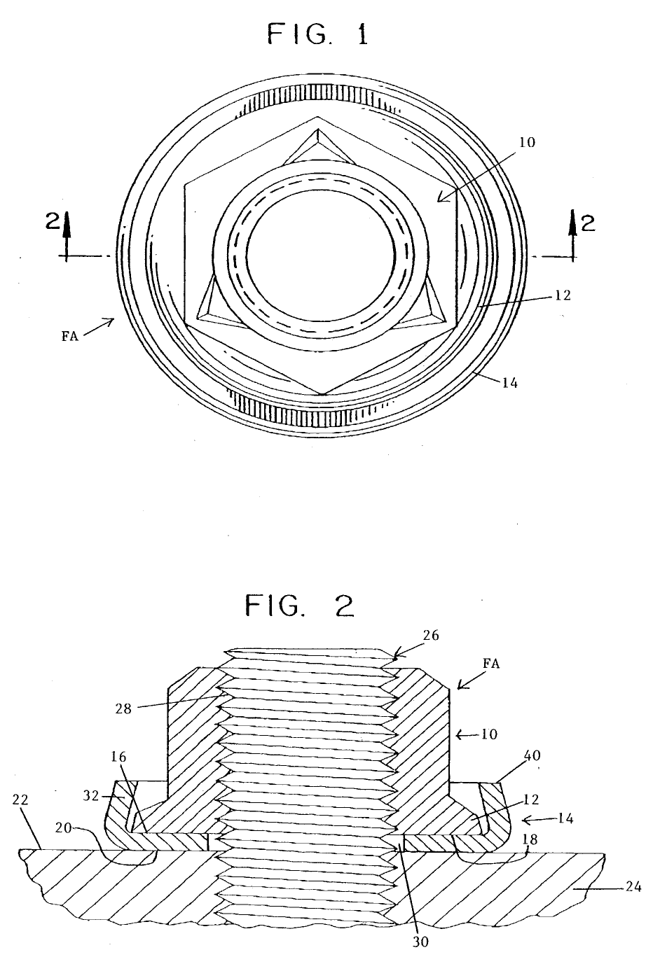

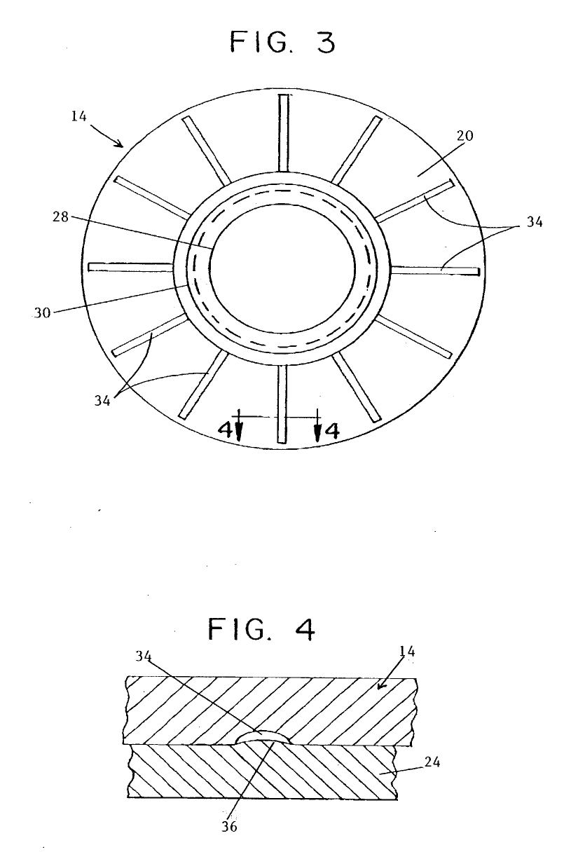

As shown in FIGS. 1 and 2, a fastener assembly FA in accordance with the invention comprises a metal nut 10 having an integral flange 12 at one end thereof and a metal cup washer 14 rotatably mounted on the flange. In the form shown in FIG. 2, the flange 12 has a truncated conical configuration with an outer disc surface 16 adjacent to an inner disc surface 18 of the cup washer. In FIG. 2, an outer disc surface 20 of the washer is shown in contact with a surface 22 of a workpiece 24 as the result of tightening of the nut 10 on a bolt 26 projecting from the workpiece. The nut has a threaded center bore 28 for engagement with the threads of the bolt, and the washer 14 has a hole 30 through which the bolt extends freely.

To hold the washer captive on the flanged nut, at least portions of the sidewall 32 of the cup washer overlie the flange 12, thereby preventing the cup washer from separating from the nut when the fastener assembly is free of the bolt. This can be achieved by staking spaced portions of the sidewall or by deforming the sidewall with a coning tool, for example, so that an entire circumferential edge 40 of the sidewall overlies the flange uniformly, as shown in FIG. 2.

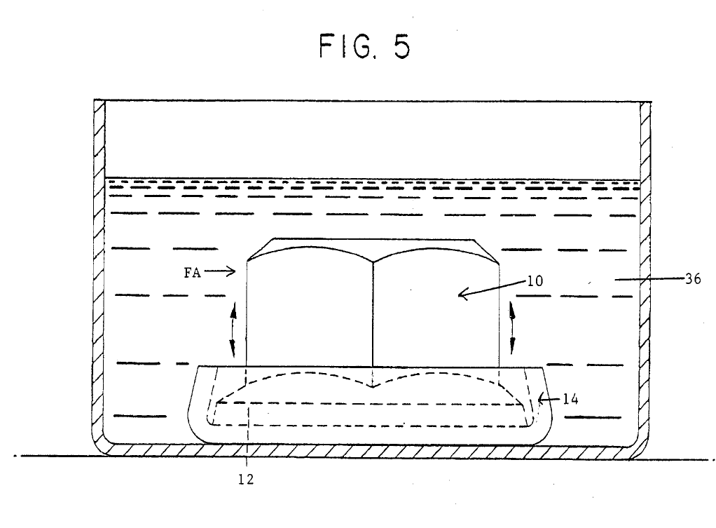

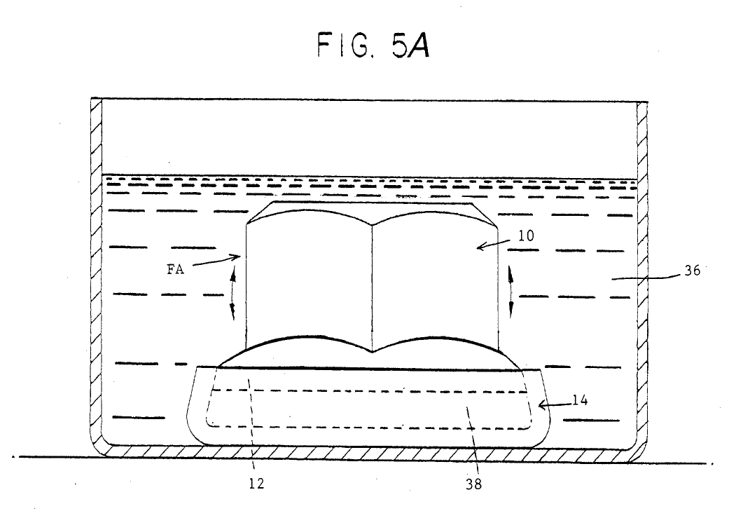

As shown in FIG. 3, the outer disc surface 20 of the cup washer is provided with a plurality of grooves 34 extending transversely to the circumference of the disc surface 20. In a preferred embodiment, the grooves extend radially over substantially the entire radial extent of the disc surface 20. In this embodiment, which includes twelve equally spaced grooves 34 (although the number of grooves can be varied), the disc surface 20 is smooth and substantially flat, except for the grooves. As shown in FIG. 4, in this embodiment, the groove cross-section is substantially U-shaped, and there are no sharp edges. In one embodiment, each groove has a width of about 1.00 mm and a depth of about 0.25 mm.

The flanged nut and the cup washer are preferably formed of steel and may be used with a workpiece that is aluminum or painted steel, for example. The nut and the washer may be made from 1035 steel, for example. The nut may have a hardness of 26-36 RC, for example, and the washer may have a hardness of 40-48 RC, for example.

The clamping force exerted upon the workpiece when the nut 10 is tightened is believed to cause minute displacement of the surface of the workpiece into the grooves, as shown at 36 in FIG. 4. This displacement, being miniscule, is insufficient to cause noticeable marring of the surface 22 of the workpiece, as would occur if the workpiece-engaging surface of the washer were roughened by knurling or ribbing, for example.

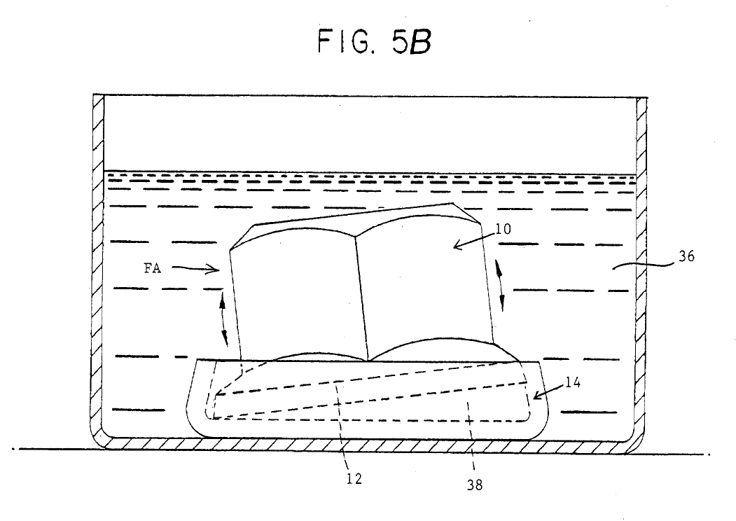

As part of a preferred manufacturing method of the invention, the entire fastener assembly FA, including all of its surfaces, is coated as a unit, with an anti-corrosive lubricant. As shown in FIGS. 5, 5A and 5B, the coating material can be applied by immersing the entire fastener assembly in a liquid bath 36 of the anti-corrosive lubricant. The coating material may be a zinc-rich organic paint, for example, and a Teflon enriched topcoat may be applied. Magni 511 may be used, for example, as the zinc-rich organic material.

To facilitate the coating operation, the mounting of the washer 14 on the flange 12 of the nut is preferably sufficiently loose as to allow substantial relative movement between the flanged nut and the washer, axially, laterally, and tiltingly, whereby a substantial space 38 can be provided between the outer disc surface 16 of the flange and the inner disc surface 18 of the washer, as shown in FIGS. 5A and 5B.

The nut can be moved away from the washer to an extent at which the overlying portions of the circumferential edge 40 of the sidewall 32 of the washer are in contact with the flange 12, as shown in FIGS. 5A and 5B. In one embodiment, the axial movement of the flange 12 relative to the washer 14 extends over a distance that is a major portion of the height of the sidewall 32 of the washer, as shown in FIG. 5A, and the tilting movement of the nut 10 relative to the washer 14 is such that a portion of the outer disc surface 16 of the flange reaches the circumferential edge 40 of the sidewall of the washer, as shown in FIG. 5B.

By virtue of the provision of such relative movement between the flanged nut 10 and the washer 14, which can be caused by agitation in the bath 36 (indicated generally by the arrows in FIGS. 5, 5A, and 5B), the substantial space 38 provided between the outer disc surface 16 of the flange and the inner disc surface 18 of the washer facilitates entry of the coating material in the liquid bath 36 into the space 38. After liquid coating, the fastener assemblies are dried, as in an oven, for example.

When the nut of a fastener assembly of the invention is tightened on a bolt projecting from a workpiece so as to clamp the cup washer against a surface of the workpiece, the washer may turn slightly with the nut relative to the workpiece as the nut is initially tightened, but then the nut will turn relative to the washer to provide a predetermined desired torque that is retained dependably without marring the workpiece.

Even though the workpiece-engaging surface of the washer is coated with a lubricant, the grooves on that surface ensure that the frictional force at the interface between the washer and the workpiece is greater than the frictional force at the interface between the flange and the washer, so that the washer is held stationary relative to the workpiece (after perhaps an initial slight rotation) and the nut rotates relative to the washer.

While preferred embodiments of the invention have been shown and described, it will be apparent that changes can be made without departing from the principles and spirit of the invention, the scope of which is defined in the accompanying claims.

What is claimed is:

1. A fastener assembly comprising:
a metal nut having an integral flange at one end; and
a metal cup washer rotatably mounted on the flange of the nut, with an outer disc surface of the flange adjacent to an inner disc surface of the washer, and with at least portions of a sidewall of the washer overlying the flange of the nut,
wherein an outer disc surface of the washer, for engagement with a surface of a workpiece, has a plurality of grooves extending transversely to the circumference of the outer disc surface of the washer.

2. A fastener assembly according to claim 1, wherein the grooves are disposed radially on the outer disc surface of the washer.

3. A fastener assembly according to claim 1, wherein all surfaces of the fastener assembly have a corrosion-resistant lubricant coating thereon.

4. A fastener assembly according to claim 1, wherein the sidewall of the washer has a circumferential edge that uniformly overlies the flange.

5. A fastener assembly according to claim 1, wherein the mounting of the washer on the flange of the nut is sufficiently loose that the outer disc surface of the flange of the nut can move away from the inner disc surface of the washer by a distance that is a major portion of the height of the sidewall of the washer.

6. A fastener assembly according to claim 1, wherein the disc surfaces of the flange and the washer are substantially flat.

7. A fastener assembly according to claim 1, wherein the nut and the cup washer are made of steel.

8. A fastener assembly according to claim 1, wherein the outer disc surface of the washer is smooth except for the grooves.

9. A fastener assembly according to claim 1, wherein the mounting of the washer on the flange of the nut is sufficiently loose that the nut can move axially, laterally, and tiltingly relative to the washer by substantial amounts.

10. A method of making a fastener assembly that includes a nut having an integral flange at one end and a cup washer, comprising:
rotatably mounting the cup washer on the flange of the nut so that an outer disc surface of the flange is adjacent to an inner disc surface of the cup washer, so that at least portions of a sidewall of the cup washer overlie the flange, so that the mounting of the washer on the flange is sufficiently loose to allow the nut to move relative to the cup washer axially, laterally, and tiltingly by substantial amounts, and so that movement of the outer disc surface of the flange away from the inner disc surface of the cup washer provides a substantial space between the outer disc surface of the flange and the inner disc surface of the cup washer when said portions of the sidewall of the cup washer are contiguous with the flange;
providing a plurality of grooves in an outer disc surface of the cup washer transversely to the circumference thereof; and
coating the entire fastener assembly, as a unit, with an anti-corrosive lubricant material.

11. A method according to claim 10, wherein the grooves are provided radially in the outer disc surface of the cup washer.

12. A method according to claim 10, wherein the grooves are formed in a substantially flat, smooth outer disc surface of the cup washer and so that their cross-section is substantially U-shaped.

13. A method according to claim 10, wherein the sidewall of the cup washer is deformed so that a circumferential edge of the sidewall overlies the flange uniformly.
